(19) United States
(12) Patent Application Publication
(10) Pub. No.: US 2022/0146014 A1
(43) Pub. Date: May 12, 2022

(54) VALVE DRIVE DEVICE, A METHOD FOR OPERATING A VALVE DRIVE DEVICE, AND A PROCESS DEVICE

(71) Applicant: Festo SE & Co. KG, Esslingen (DE)

(72) Inventors: Wolfgang Rieger, Kongen (DE); Martin Eckert, Hochdorf (DE)

(21) Appl. No.: 17/517,286

(22) Filed: Nov. 2, 2021

(30) Foreign Application Priority Data
Nov. 6, 2020 (DE) 102020213974.1

(51) Int. Cl. F16K 31/363; F16K 37/00

(52) U.S. Cl. CPC F16K 31/363; F16K 37/0041

(57) ABSTRACT

A valve drive device is provided, with a fluid-actuated valve drive (25) which includes a drive unit (23) which has a drive housing (27) which defines a housing interior (26) and in which a drive piston (28) of the drive member (24) is movably received and divides the housing interior (26) into two working chambers (29a, 29b), of which at least one can be subjected to fluid, with a force monitoring device (37) for monitoring the actuation force which is generated by fluid pressure and acts upon the drive piston (28), with a position monitoring device (60) for monitoring the position of the drive piston (28) and with an electronic control device (41) for controlling the valve drive (25) on the basis of the force and position data which is provided by the force monitoring device (37) and the position monitoring device (60).

### BACKGROUND OF THE INVENTION

The invention relates to a valve drive device, with a fluid-actuated valve drive which comprises a drive unit which comprises a drive housing which defines a housing interior and in which a drive piston of the driven member is movably received and divides the housing interior into two working chambers, of which at least one can be subjected to fluid. The invention further relates to a method for operating a valve drive device and to a process device.

Such valve drive devices have already been known for some time now, for example as constituents of process valves, concerning which they ensure the movement of the valve member, in order to herewith control the through-flow of process medium.

Likewise known are process devices which have one or more reaction containers in which process medium is located, said process medium being processed, treated or able to be treated further. An example of such a process device is a solid-liquid separating device for separating solid matter from liquids.

On operation of valve drive devices and process devices, there is the necessity to recognise disturbances in the course of the operation and to react to these with suitable counter-measures.

### SUMMARY OF THE INVENTION

It is therefore the object of the invention to provide a valve drive device and a process device of the initially mentioned type, which have a high operational reliability and to provide a method for the operation of a valve drive device, with which a high operational reliability is ensured, by which means the probability of failure is minimized.

This object is achieved by a valve drive device with the features of the independent claim 1, a method for operating a valve drive device with the features of the independent claim 16 and a process device with the features of the independent claims 22. Further developments of the invention are represented in the dependent claims.

The valve drive device according to the invention comprises a fluid-actuated valve drive which has a drive unit which comprises a drive housing which defines a housing interior and in which a drive piston of the drive member is movably received and divides the housing interior into two working chambers, of which at least one can be subjected to fluid pressure, with a force monitoring device for monitoring the actuation force which is generated by fluid pressure and acts upon the drive piston, with a position monitoring device for monitoring the position of the drive piston and with an electronic control device for controlling the valve drive on the basis of the force and position data which is provided by the force monitoring device and the position monitoring device.

The actuation force which acts upon the drive piston as well as the position of the drive piston are monitored, in order to determine possible disturbances which can neither be detected solely by way of a force monitoring nor solely by way of a position monitoring. By way of this, the operational reliability of the valve drive device is increased.

Concerning a further development of the invention, the electronic control device comprises a comparator device with an electronic memory, in which end positions of the drive piston and a maximum actuation force can be stored or are stored, and wherein by way of the comparator device, an actual actuation force which is determined by way of the force monitoring device can be compared with the maximum actuation force and an actual position of the drive piston which is determined by way of the position monitoring device can be compared with the end positions.

With the closed-loop control operation of the valve drive device, it is possible to determine an unexpected increase of the force or an absence of an expected increase of the force, in the region which is set by the customer.

In a particularly preferred manner, the electronic control device is configured in a manner such that on exceeding the maximum actuation force and given an actual position unequal to the end positions, a switch-off signal for the valve drive can be outputted. By way of this, it is possible to stop the drive movement which is generated by way of the valve drive, in the case of an actuation force which lies too high above a limit value, so that damage to the valve drive or to a valve member of a valve arrangement which is coupled to the valve drive can be avoided. In particular, it is possible to detect whether obstacles are located in the displacement path of the valve member, said obstacles hindering or even preventing the movement of the valve member into the desired valve member end positions.

The absence of an expected force increase, in particular on retracting into the end position can also provide information. This can also indicate a disturbance, for example the fact that the seal which is assigned to the valve member is absent or damaged.

Concerning a further development of the invention, the force monitoring device comprises pressure detection means for detecting the working pressure which prevails in the assigned working chamber.

In a particularly preferred manner, the pressure detection means comprise at least one pressure sensor, with which the actual pressure in the assigned working chamber can be detected and can be transmitted to the comparator device by way of a pressure sensor sensor signal which is assigned to the detected actual pressure. Concerning the fluid-actuated valve drive, it can be a dual-acting valve drive, concerning which the working chamber which is remote from the piston rod as well as the working chamber through which the piston rod passes can be subjected to pressurised air. It is possible for the pressure sensors to each be arranged at the face-side end of the assigned working chamber. By way of pressure sensors, it is possible to detect the actual pressure in the working chamber and to transmit it to the comparator device in particular by way of wireless electronic pressure sensor sensor signals. Alternatively to the dual-acting valve drive, one can also use a single-acting valve drive with a spring restoration.

The valve drive can be designed as a linear drive or as a rotation drive.

In a particularly preferred manner, parameters of different types of valve drives can be stored or are stored in the electronic memory of the comparator device, wherein the parameters comprise a piston area of the drive piston which is assigned to the first working chamber and possibly with dual-acting valve drives the piston areas which are assigned to the second working chamber, in order from this to determine an actual actuation force with the help of the detected actual pressure.

Concerning a further development of the invention, a control valve device is provided for generating a drive movement of the drive piston.

Concerning a further development of the invention, an operating pressure monitoring device is provided for monitoring the operating pressure which is fed to the control valve device. Herewith, one can determine whether the minimum operating pressure which is necessary for the drive of the piston is present. Furthermore, it can be determined whether the operating pressure exceeds an allowable maximum operating pressure, by which means damage to the valve drive due to wearing which is caused by an increased operating pressure or due to an increased actuation force which results on account of the increased operating pressure can be avoided.

Concerning a further development of the invention, the operating pressure monitoring device in particular comprises at least one pressure detection means which comprises a sensor, for detecting the actual operating pressure, wherein the detected actual operating pressure can be transmitted to the comparator device, in order to carry out a comparison with an allowable minimum operating pressure and an allowable maximum operating pressure and on falling short of the minimum operating pressure or on exceeding the maximum operating pressure to output a diagnosis signal.

Concerning a further development of the invention, a voltage supply monitoring device is provided for monitoring the voltage supply of the electronic components of the process device, in particular the input voltage of the control valve device. Expediently, the control valve device comprises several control valves which are each controlled via pilot valves. The pilot valves are preferably electromagnet valves. Hence with the voltage supply monitoring device one can for example monitor whether the pilot valves of the control valve device are operationally ready.

Concerning a further development of the invention, the electronic control device comprise an output device for the output of diagnosis signals.

The individual components of the electronic control device can be grouped together centrally in particular into subassemblies. However, it is alternatively also possible for the components of the electronic control device to be arranged decentrally.

Concerning a further development of the invention, the position monitoring device comprises a path measuring unit for determining the actual position of the drive piston along its displacement path.

Expediently, the path measuring unit is a path measuring system which measures in a contact-free manner. It is possible for the path measuring unit to be integrated into the drive housing of the drive unit. Expediently, the path measuring unit or the path measuring system comprises at least one in particular strip-like path measuring sensor.

Concerning a further development of the invention, the position monitoring device comprises a time measuring device, via which the determining of the displacement time which the drive piston requires in order to be displaced between the actual position into a new desired position is possible, wherein the displacement time can be transmitted to the comparator device, in order to carry out a comparison with a predefined maximum displacement time, on exceeding which a diagnosis signal can be outputted.

Concerning a further development of the invention, a maintenance unit which is arranged in front of the control valve device is provided, said maintenance unit comprising a pressure controller for the closed-loop control of a supply pressure which originates from a pressure source, to the operating pressure. The maintenance unit additionally to the pressure controller can yet comprise a filter and/or an oiler.

Concerning a further development of the invention, the electronic control device and the control valve device are grouped into a control subassembly. This control subassembly can be accommodated for example centrally in a switch cabinet.

The invention further relates to a valve arrangement with a valve fitting, through which process medium can flow and in which a valve seat which surrounds a through-flow opening is arranged, to which valve seat a valve member which is arranged on an actuation rod is assigned in a manner such that the valve member by way of actuation travel of the actuation rod is movable between a shut-off position, in which the valve member sealingly bears on the valve seat in a process-medium-tight manner, and an open position, in which the valve member is lifted from the valve seat, and with a valve drive device for generating the actuation travel of the actuation rod, wherein the valve drive device is designed according to one of the claims 1 to 14.

Furthermore, the invention relates to a method for operating a valve drive device which has a fluid-actuated valve drive which comprises a drive unit which comprises a drive housing which defines a housing interior and in which a drive piston of the drive member is movably received and divides the housing interior into two working chambers, of which at least one can be subjected to fluid, wherein the actuation force which is generated by way of fluid pressure and which acts upon the drive piston is monitored with a force monitoring device which belongs to the valve drive device, the position of the drive piston is monitored with a position monitoring device which belongs to the valve drive device and the valve drive is controlled with an electronic control device which belongs to the valve drive device.

Concerning a further development of the method according to the invention, the electronic control device comprises a comparator device which comprises an electronic memory, in which end positions of the drive piston and a maximum actuation force are stored or become stored, and wherein by way of the comparator device an actual actuation force which is determined by way of the force monitoring device is compared to the maximum actuation force and an actual position of the drive piston which is determined by way of the position monitoring device is compared to the end positions.

Concerning a further development of the method according to the invention, on exceeding the maximum actuation force and given an actual position unequal to the end positions, the electronic control device emits a switch-off signal for the valve drive.

In a particularly preferred manner, for determining the end positions of the drive piston, an initialisation journey is carried out, concerning which the drive piston which is situated in a starting position is subjected to an actuation force which is generated by fluid pressure, so that it is moved in a first direction, wherein the position at which the actuation force which acts upon the drive piston exceeds a maximum actuation force, which is detected by the force monitoring device, is defined as the first end position.

Concerning a further development of the invention, in the case of the design of the valve drive as a single-acting valve drive, the starting position of the drive piston defines the second end position.

In the case of the design of the valve drive as a dual-acting valve drive, the initialisation journey can be carried out in directions which are opposite to one another. The drive piston can therefore be subjected to an actuation force which is generated by fluid pressure, so that it is moved in a second direction which is opposite to the first direction, wherein the position at which the actuation force which acts upon the drive piston exceeds a maximum actuation force, which is detected by the force monitoring device, is defined as a second end position.

Finally, the invention includes a process device with at least one reaction container which comprises a container housing and a reaction space which is fillable or is filled with process medium, wherein the container housing comprises at least one exit opening for process medium and a mechanically actuated outlet valve for the control of the opening cross section of the exit opening is assigned to the exit opening, wherein the outlet valve comprises a valve member which is connected to an actuation rod which is a constituent of a drive unit of a fluid-actuated valve drive which is provided with a drive member, wherein the drive unit comprises a drive housing which defines a housing interior and in which a drive piston of the drive member is movably received and divides the housing interior into two working chambers, of which at least one can be subjected to fluid, wherein the drive piston is coupled to the actuation rod via coupling means, and with a control valve device for generating a drive movement of the drive piston, and with a force monitoring device for monitoring an actuation force which is exerted upon the valve member and/or with a vibration monitoring device for monitoring the vibrations of the actuation rod which occur on operation.

The movement of the drive piston in the housing interior effects a displacement of the piston rod and thus of the actuation rod. An actuation force which is exerted upon the valve member results from this. Expediently, at least the working chamber which is remote from the piston rod is subjected to pressurised fluid, by which means the movement of the drive piston effects a pushing-out of the piston rod. As a rule, on account of such a subjection of the working chamber, the coupled actuation rod is moved such that the valve member is moved in a closure direction, by which means the opening cross section of the exit opening is reduced in size. In particular, this closure force which is exerted upon the valve member, but also an oppositely acting opening force are important parameters, the monitoring of which increasing the operational reliability of the outlet valve, since on account of this faulty functioning is recognisable in good time. On account of the force monitoring device, it is therefore possible to monitor this actuation force which is exerted upon the valve member and to stop the drive movement which is produced by way of the linear drive, in the case of an actuation force which lies to highly above a limit value, so that damage in particular to the actuation rod or to the valve member is avoided.

It is alternatively or additionally possible to detect vibrations of the actuation rod which occur on operation by way of the vibration monitoring device. It is possible to detect axial vibrations of the actuation rod which then occur when the valve member is situated in the proximity of its closure position and the suction effect of the flowing-through process medium then effects a movement of the actuation rod in the direction of the closure position and then a restoring of the activation rod for example via a control device and a position recognition is effected, and this procedures is then successively repeated several times.

As a whole, the operational reliability of the linear drive of the process device and therefore of the process device as a whole is significantly increased by way of the force monitoring device and/or vibration monitoring device.

### BRIEF DESCRIPTION OF THE DRAWINGS

A preferred embodiment example of the invention is represented in the drawing and is explained in more detail hereinafter. In the drawing are shown in:

FIG. 1 a schematic representation of a preferred embodiment example of the process device according to the invention, with which the valve drive device according to the invention is applied,

FIG. 2 a schematic illustratory picture of the valve drive device according to the invention.

### DETAILED DESCRIPTION

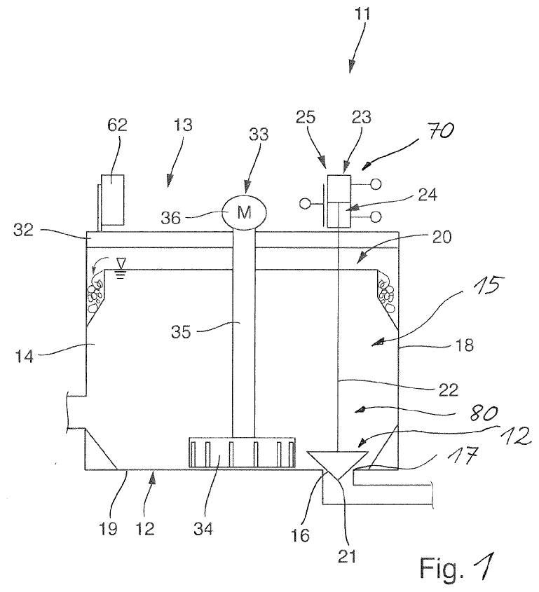

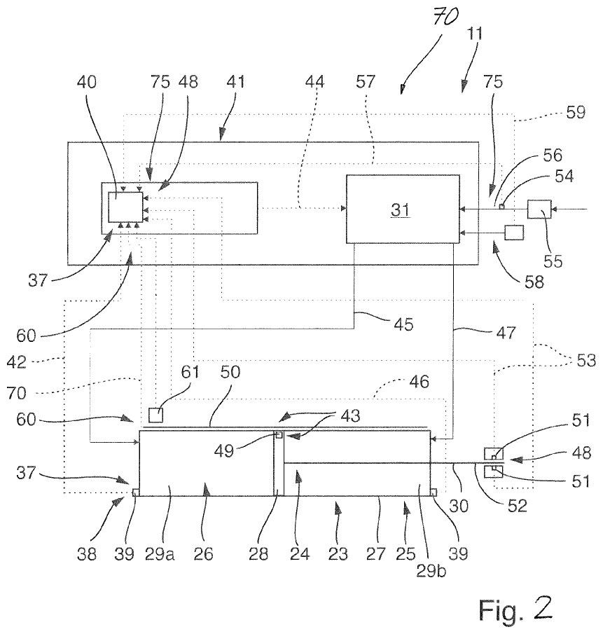

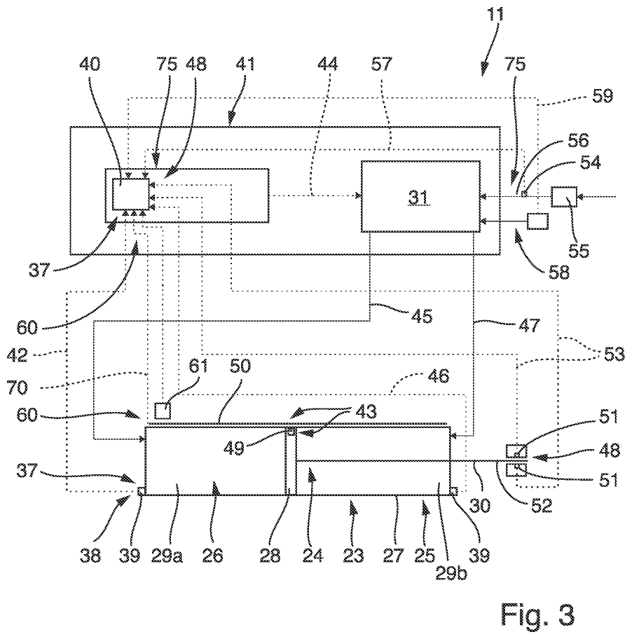

FIGS. 1 and 2 shows a preferred embodiment example of the valve drive device 70 according to the invention, as a constituent of the process device 11 according to the invention. The process device 11 hereinafter purely by way of example is described on the basis of a device for solid-fluid separation. Of course, the invention can also be applied to other types of process devices 11. The description of the solid-fluid separation apparatus, as mentioned, is purely by way of example.

The process device 11 comprises at least one reaction container 13 which comprises a container housing 12 and a reaction space 15 which can be filled or is filled with process medium 14.

As is particularly shown in FIGS. 1 and 2, the container housing 12 of the process container 12 comprises at least one exit opening 16 for process medium 14. The process medium in the case of a solid-liquid separating device in particular is present as an aqueous suspension.

The process medium 14 flows via the entry opening 17 into the reaction container 13, in which a solid-liquid separating process is carried out.

As a rule, the exit opening 16 is located on a container wall 18 or as in the shown embodiment example on the container base 19 of the container housing 12.

An essential element of the process device 11 is a mechanically actuated outlet valve 20 which is assigned to the exit opening 16 of the respective reaction container 13 and via which the opening cross section of the exit opening 16 can be controlled. The opening cross section can therefore be selectively reduced or increased in size via the outlet valve 20.

As is particularly shown in FIGS. 1 and 2, the outlet valve 20 comprises a valve member 21 which is connected to an actuation rod 22. The valve member 21 in the shown example is designed in a cone-shaped manner.

The actuation rod 22 is a constituent of a drive unit 23 of a fluid-actuated valve drive 25 which is provided with a drive member 24 and which by way of example is represented in the form of a linear drive and is described in more detail hereinafter.

As is shown by way of example in FIG. 2, the drive unit 23 comprises a drive housing 27 which defines a housing interior 26 and in which a drive piston 28 of the drive member 24 is received in a linearly movably manner and subdivides the housing interior 26 into two working chambers 29a, 29b. At least one of the working chambers 29a, 29b can be subjected to fluid pressure by way of a working fluid, in particular pressurized air.

In the shown example case, a dual-acting linear drive is provided, with which both drive chambers 29a, 29b can be subjected to fluid pressure by way of working fluid.

The drive piston 28 is connected to a piston rod 30 which is led out of the drive housing 27 and which for its part is coupled to the actuation rod 22.

A control valve device 31 is assigned to the drive unit 23, via which control valve device a retracting or an extending linear drive movement of the drive piston 28 can be selectively generated.

As is particularly shown in FIGS. 1 and 2, the drive unit 23 of the valve drive 25 is situated outside of the reaction space 15, for example above a container lid 32 of the reaction container 13. The drive unit 23 is expediently fastened to the container lid 32, wherein the actuation rod 22 passes through the container lid 32 and the reaction space 15 and the exit opening 16 with the valve member 21 which is coupled onto the free end of the actuation rod 22 is controlled by a drive movement.

As in particular the FIGS. 1 and 2 show, the process device 11 in the exemplary case has a stirring device 33 which has a stirring element 34 which is driven in rotation via a drive shaft 34. As is shown in FIGS. 1 and 2 by way of example, a stirring drive 35 is situated outside the reaction container 13, wherein the stirring device 35 brings the drive shaft 34 into a rotation movement. The drive shaft 34 passes through the container lid 32 and the reaction space 15 and extends up to the proximity of the container base 19, wherein the drive shaft 34 is then connected to a stirring element 34.

In the case of a solid-liquid separation, a suspension gets into the reaction space 15 via the entry opening 17. Air can be brought in and finely distributed by way of the stirring device and/or lances (not represented). Air which is blown into the suspension only sticks to the hydrophobic particles and carries them to the water surface, whereas the hydrophilic particles remains in the slurry.

The solid matter particles which have floated up by way of this are then removed via a clearing device, for example they flow away via a weir.

The remaining slurry then goes out of the reaction container 13 via the exit opening 16.

As already mentioned, the control of the exit opening 16 is effected via the assigned outlet valve 20. The outlet valve 20 is controlled via the valve drive device 70 which in turn is part of a valve arrangement 80, to which apart from the valve drive device a valve fitting belongs, in which valve fitting a valve seat which surrounds a through-flow opening is arranged. In the described example case, the valve fitting is formed by the container housing 12, in particular by the container base 19. The through-flow opening is the exit opening 16.

There is the requirement for the valve drive device 70 to work in an operationally reliable manner and for the probability of failure to be very low.

For this, the valve drive device 70 comprises a force monitoring device 37 for monitoring the actuation force which is produced by fluid pressure and which acts upon the drive piston 28, and a position monitoring device 60 for monitoring the position of the drive piston 28. The valve drive device 70 further comprises an electronic control device for controlling the valve drive 25 on the basis of force and position data which is provided by the force monitoring device 37 and the position monitoring device 60.

As is particularly shown in FIG. 2, the force monitoring device 37 comprises pressure detection means 38 for detecting the working pressure which prevails in the assigned working chamber 29a, 29b.

As is particularly shown in FIG. 2, the pressure detection means 38 comprise pressure sensors 39, with which the actual pressure in the assigned working chamber 29a, 29b can be detected.

The valve drive device 70 further comprises a comparator device 40 which—as is shown in FIG. 2—is a constituent of an electronic control device 41.

The electronic control device can be connected to a superordinate control via a communication interface. A connection to a data cloud is possible.

The comparator device 40 comprises an electronic memory, in which end positions of the drive piston 28 and maximum actuation force can be stored or are stored. Furthermore, parameters of different types of valve drives 25, in the exemplary case of dual-acting linear drives can be stored or are stored in the electronic memory. In the case of a dual-acting linear drive, parameters include a piston area of the drive piston 28 which is assigned to the first working chamber 29a and additionally the piston area which is assigned to the second working chamber 29b, in order from this to determine an actual actuation force with the help of the detected actual pressure.

As is particularly shown in FIG. 2, the pressure sensors 39a, 39b are capable of detecting the actual pressure in the assigned working chamber 29a, 29b and of transmitting it to the comparator device 40 by way of a pressure sensor sensor signal 42, 46 which is assigned to the detected actual pressure. As a rule, the pressure sensors each have a P/V transducer which converts the detected actual pressure into an electronic sensor signal which is transmitted to the comparator device 40, in particular in a wireless manner.

The force monitoring at the valve drive 25 given the example of a dual-acting linear drive takes its course in the following manner:

In dependence on the applied linear drive, a maximum actuation force which is allowable for the drive piston 28 is determined and is stored in the electronic memory.

Next, the end positions of the drive piston 28 must be determined, and these then in the electronic memory serve as the basis for the force monitoring in regular operation.

For this, an initialisation journey is carried out. Concerning the initialisation, one of the two working chambers is firstly subjected to fluid pressure. The actual pressure in the working chamber 29a which is subjected to fluid pressure is monitored by the assigned pressure sensor 39a and the values of the actual pressure are transmitted to the comparator device 40 via first pressure sensor sensor signals 42. In the comparator device, a conversion into an actual actuation force takes place via the stored piston area. The actual actuation force is compared to a stored allowable maximum actuation force. If the actual actuation force lies above the stored maximum actuation force, then the position of the drive piston, at which an exceeding of the maximum actuation force has taken place is stored in the electronic memory as the first end position.

The working chamber 29a which was previously subjected to fluid pressure is subsequently de-vented and the other working chamber 29b is subjected to pressurised fluid. The drive piston 28 now moves in the opposite direction. The actual pressure in the other working chamber 29b is monitored by the assigned pressure sensor 39b and the values of the actual pressure are transmitted to the comparator device 40 via second pressure sensor sensor signals 46. There, a conversion into an actual actuation force takes place via the stored piston area. The actual actuation force is compared with a stored allowable maximum actuation force. If the actual actuation force lies above the stored maximum actuation force, then the position of the drive piston at which an exceeding of the maximum actuation force has taken place is stored in the electronic memory as a second end position.

In regular operation, the actual pressure of the respective working chamber 29a, 29b which is subjected to pressurised fluid is monitored with the respectively assigned pressure sensor 39a, 39b and the values of the actual pressure are transferred to the comparator device 40 via first or second pressure sensor sensor signals 42, 46. There, a conversion into an actual actuation force takes place via the stored piston area. The actual actuation force is compared to the stored allowable maximum actuation force. If the actual actuation force lies below the stored maximum actuation force, then no error is present and therefore there is no necessity to intervene.

On subjecting the working chambers 29a, 29b to pressurised air, a characteristic course of the actual pressure occurs over the displacement path up to the desired end position or end location. The actual operating pressure firstly increases since the drive piston 28 must firstly be brought into motion and stick-slip effects of the drive piston 28 are possibly to be overcome. This initial pressure peak of the actual pressure and the resulting peak of the actuation force however also lie below the stored maximum actuation force. so that the pressure build-up is continued. The actual pressure subsequently drops again since for example the drive piston 28 moves to the right and by way of this the volume of the first working chamber 29a becomes larger.

If now in regular operation an exceeding of the maximum actuation force is detected and the drive piston 28 is not located in one of the two end positions, then this is assessed as a disturbance. In the case of a process device with a valve member, this for example can indicate an obstacle in the displacement path of the valve member. If this situation occurs, then the electronic control device emits a switch-off signal.

If, in contrast, the expected force increase does not occur in one of the end positions, then this also indicates a disturbance, for example the valve seal on the valve seat of the valve element could be damaged or even be missing. In the latter-mentioned case, the drive piston 28 travels beyond in the set end position, since on account of the absence of the seal the displacement path of the valve member up to the stop is longer.

During the initialisation journey, it is also possible to determine the course of the force of the actuation force which acts upon the drive piston, from the one to the other end position. If in regular operation the actual actuation force differs from the curve course, then this can indicate a disturbance, for example given a curve of the actual actuation force which lies above the setpoint curve which is determined on initialisation, this could indicate an increased friction.

The position monitoring device 60 comprises a path measuring unit 43 which comprises at lets one permanent magnet 49 which is arranged on the drive piston 28. The path measuring unit 43 in particular is configured for the contact-free path measurement, for example inductive or capacitive path measurement.

Furthermore, the path measuring unit 43 comprises a strip-like path measuring sensor 50 which extends over the displacement path 27 of the drive piston 28. The strip-like path measuring sensor 50 can be integrated for example into the drive housing 27 of the drive unit 23.

The actual position of the drive piston 28 can be detected by way of the position of the permanent magnet 49 with respect to the strip-like path measuring sensor 50. The path measuring sensor 50 is capable of outputting path measurement sensor sensor signals 70 to the comparator device 40.

The valve drive device 70 further comprises a vibration monitoring device 48, with which axial vibrations of the actuation rod 22 can be monitored.

In the case of axial vibrations of the actuation rod 22, a multitude of position changes of the drive piston 28 which can be detected via the comparator device 40 occurs. Such axial vibrations of the actuation rod 22 can occur above all if the valve member is situated in the vicinity of its closure position and process medium which flows away, for example through the exit opening 16 which is situated on the container base 19, ensures that the valve member is moved in the direction of the closure position. Since this however is a faulty function, this is compensated by the electronic control or closed-loop control which leads to a restoring of the valve member into its initial position. However, the suction effect then directly occurs again and displaces the valve member again in the direction of the closure position. Thus axial oscillations occur and these could damage the actuation rod 22. There is the possibility to prevent this by way of the vibration monitoring device with the path measuring unit 43. As a counter-measure, for example the pressure in the two working chambers 29a, 29b can be increased, in order to increase the stiffness of the air springs.

The valve drive device 70 further comprises an operational pressure monitoring device 75 for monitoring an operating pressure which is fed to the control valve device 31. As is schematically shown in FIG. 2, the operational pressure monitoring device 75 comprises pressure detection means which comprise at least one pressure sensor 54 for detecting the actual operating pressure.

It is further possible for a maintenance unit 55 to be assigned to the valve drive 25, said unit having a pressure controller, via which the supply pressure which originates from a pressure source can be reduced to the operating pressure which as a rule lies between 6 bar and 8 bar. The pressure sensor for monitoring the actual operating pressure is expediently located in the operating pressure feed 56 and emits pressure sensor sensor signals 57 to the comparison device 40. There, a comparison with an allowable minimum operating pressure and an allowable maximal operating pressure takes place, wherein on falling short of the minimum operating pressure or exceeding the maximum operating pressure a diagnosis signal 44 is outputted. On falling short of the minimum operating pressure, for example the pressure controller of the maintenance unit 55 can be controlled such that the operating pressure is increased to an allowable value.

The process device 11 further comprises a voltage supply monitoring device 58 for monitoring the voltage supply of the electronic components of the process device, in particular the input voltage of the control valve device 31. The voltage supply monitoring device 58 is capable of outputting sensor signal 59 to the comparator device, in which a minimum voltage is stored. If the determined actual supply voltage falls short of the minimum supply voltage, the suitable counter-measures can be initiated. An electricity failure can also be reliably detected by way of this.

Furthermore, a time measuring device 61 belongs to the position monitoring device 60, via which time measuring device the detection of the displacement time which the drive piston 28 requires in order to be displaced between the actual position into at new desired position is possible, wherein the displacement time can be transmitted to the comparator device by way of suitable sensor signals 62, in order to carry out a comparison with a predefined maximum displacement time, on exceeding which a diagnosis signal 44 can be outputted. The exceeding of the maximum displacement time can for example be caused by obstacles being present in the displacement path of the valve member 21 and slowing down the movement of the valve member. Furthermore a slow displacement time which lies below the minimum displacement time can also indicate wear on the drive piston.

As is particularly shown in FIGS. 1 and 2, the control valve device 31 and the electronic control device 41 can be grouped together into a control subassembly. The control subassembly can be accommodated for example centrally in a switch cabinet 62.

What is claimed is:

1. A valve drive device with a fluid-actuated valve drive which comprises a drive unit which comprises a drive housing which defines a housing interior and in which a drive piston of the drive member is movably received and divides the housing interior into two working chambers, of which at least one can be subjected to fluid, with a force monitoring device for monitoring the actuation force which is generated by fluid pressure and acts upon the drive piston, with a position monitoring device for monitoring the position of the drive piston and with an electronic control device for controlling the valve drive on the basis of the force and position data which is provided by the force monitoring device and the position monitoring device.

2. The valve drive device according to claim 1, wherein the electronic control device comprises a comparator device which has an electronic memory, in which end positions of the drive piston and a maximum actuation force can be stored or are stored, and wherein, by way of the comparator device, an actual actuation force which is determined by way of the force monitoring device can be compared with the maximum actuation force, and an actual position of the drive piston which is determined by way of the position monitoring device can be compared with the end positions.

3. The valve drive device according to claim 2, wherein the electronic control device is configured in a manner such that on exceeding the maximum actuation force and given an actual position unequal to the end positions, a switch-off signal for the valve drive can be outputted.

4. The valve drive device according to claim 1, wherein the force monitoring device comprises pressure detection means for detecting the working pressure which prevails in the assigned working chamber.

5. The valve drive device according to claim 4, wherein the pressure detection means comprise at least one pressure sensor, with which the actual pressure in the assigned working chamber can be detected and can be transmitted to the comparator device by way of a pressure sensor sensor signal which is assigned to the detected actual pressure.

6. The valve drive device according to claim 2, wherein parameters of different types of valve drives can be stored or are stored in the electronic memory of the comparator device, wherein the parameters comprise a piston area of the drive piston which is assigned to the first working chamber and as the case may be with dual-acting linear drives additionally the piston area which is assigned to the second working chamber, in order from this to determine an actual actuation force with the help of the detected actual pressure.

7. The valve drive device according to claim 1, wherein the valve drive is designed as a linear drive or as a rotation drive.

8. The valve drive device according to claim 1, further comprising a control valve device for generating a drive movement of the drive piston.

9. The valve drive device according to claim 8, further comprising an operating pressure monitoring device for monitoring the operating pressure which is fed to the control valve device.

10. The valve drive device according to claim 9, wherein the operating pressure monitoring device comprises at least one pressure detection means which comprises a sensor, for detecting the actual operating pressure, wherein the detected actual operating pressure can be transmitted to the comparator device, in order to carry out a comparison with an allowable minimum operating pressure and an allowable maximum operating pressure, and on falling short of the minimum operating pressure or on exceeding the maximum operating pressure to output a diagnosis signal.

11. The valve drive device according to claim 1, further comprising a voltage supply monitoring device for monitoring the voltage supply of the electronic components of the valve drive device, in particular the input voltage of the control valve device.

12. The valve drive device according to claim 1, wherein the position monitoring device comprises a path measuring unit for determining the actual position of the drive piston along its displacement path.

13. The valve drive device according to claim 1, wherein the position monitoring device comprises a time measuring device, via which the determining of the displacement time which the drive piston requires in order to be displaced between the actual position into a new desired position is possible, wherein the displacement time can be transmitted to the comparator device, in order to carry out a comparison with a predefined maximum displacement time, on exceeding which a diagnosis signal can be outputted.

14. The valve drive device according to claim 8, further comprising a maintenance unit, which is arranged in front of the control valve device and which comprises a pressure controller for the closed-loop control of a supply pressure which originates from a pressure source, to the operating pressure.

15. A valve arrangement, with a valve fitting, through which process medium can flow and in which a valve seat, which surrounds a through-flow opening, is arranged, to which valve seat a valve member, which is arranged on an actuation rod, is assigned in a manner such that the valve member by way of actuation travel of the actuation rod is movable between a shut-off position, in which the valve member sealingly bears on the valve seat in a process-medium-tight manner, and an open position, in which the valve member is lifted from the valve seat, and with a valve drive device for generating the actuation travel of the actuation rod, wherein the valve drive device is designed according to claim 1.

16. A method for operating a valve drive device which has a fluid-actuated valve drive which comprises a drive unit which comprises a drive housing which defines a housing interior and in which a drive piston of the drive member is movably received and divides the housing interior into two working chambers, of which at least one can be subjected to fluid pressure, wherein the actuation force which is generated by way of fluid pressure and which acts upon the drive piston is monitored with a force monitoring device which belongs to the valve drive device, the position of the drive piston is monitored with a position monitoring device which belongs to the valve drive device and the valve drive is controlled with an electronic control device which belongs to the valve drive device.

17. The method according to claim 16, wherein the electronic control device comprises a comparator device which comprises an electronic memory, in which end positions of the drive piston and a maximum actuation force are stored or become stored, and wherein by way of the comparator device an actual actuation force which is determined by way of the force monitoring device is compared to the maximum actuation force and an actual position of the drive piston which is determined by way of the position monitoring device is compared to the end positions.

18. The method according to claim 17, wherein, on exceeding the maximum actuation force and given an actual position unequal to the end positions, the electronic control device emits a switch-off signal for the valve drive.

19. The method according to claim 16, wherein, for determining the end positions of the drive piston, an initialisation journey is carried out, concerning which the drive piston which is situated in a starting position is subjected to an actuation force which is generated by fluid pressure, so that it is moved in a first direction, wherein the position at which the actuation force which acts upon the drive piston exceeds a maximum actuation force, which is detected by the force monitoring device, is defined as the first end position.

20. The method according to claim 19, wherein, in the case of the design of the valve drive as a single-acting valve drive, the starting position of the drive piston defines the second end position.

21. The method according to claim 20, wherein, in the case of the design of the valve drive as a dual-acting valve drive, the drive piston is subjected to an actuation force which is generated by fluid pressure, so that it is moved in a second direction which is opposite to the first direction, wherein the position at which the actuation force which acts upon the drive piston exceeds a maximum actuation force, which is detected with the force monitoring device, is defined as a second end position.

22. A process device, with at least one process container which comprises a container housing and a process space which is fillable or is filled with process medium, wherein the container housing comprises at least one exit opening for process medium and a mechanically actuated outlet valve for the control of the opening cross section of the exit opening is assigned to the exit opening, wherein the outlet valve comprises a valve member which is connected to an actuation rod which is a constituent of a drive unit of a fluid-actuated valve drive which is provided with a drive member, wherein the drive unit comprises a drive housing which defines a housing interior and in which a drive piston of the drive member is movably received and divides the housing interior into two working chambers, of which at least one can be subjected to fluid, wherein the drive piston is coupled to the actuation rod via coupling means, and with a control valve device for generating a drive movement of the drive piston, and with a force monitoring device for monitoring an actuation force which is exerted upon the valve member and/or with a vibration monitoring device for monitoring the vibrations of the actuation rod which occur on operation.
